(19) United States
(12) Patent Application Publication
(10) Pub. No.: US 2008/0311168 A1
(43) Pub. Date: Dec. 18, 2008

(54) PROCESS FOR COMBATING ACARIDS

(75) Inventors: Sandrine Rochat, Villeurbanne (FR); Christine Vidil, Communay (FR)

Correspondence Address: BUCHANAN, INGERSOLL & ROONEY PC, POST OFFICE BOX 1404, ALEXANDRIA, VA, 22313-1404, US

(73) Assignee: RHODIA CHIMIE, Boulogne Billancourt Cedex (FR)

(21) Appl. No.: 12/193,793

(22) Filed: Aug. 19, 2008

Related U.S. Application Data
(62) Division of application No. 10/500,699, filed on Jul. 2, 2004.

(30) Foreign Application Priority Data
Jan. 11, 2002 (FR) 02 00317

(51) Int. Cl. A01N 25/08; A01N 59/02; A01P 7/02

(52) U.S. Cl. 424/411; 424/641

(57) ABSTRACT

The invention relates to a novel use of zinc sulfide as agent for combating acarids. The invention also relates to compositions with acarid-combating properties comprising zinc sulfide as additive, in particular polymer compositions, and to yarns, fibers, filaments and articles obtained from these compositions; it is also targeted at liquid or solid compositions for cleaning and/or treating textile surfaces, in particular carpets, including fitted carpets.

### CROSS-REFERENCE TO EARLIER APPLICATIONS

This application is a divisional application of earlier copending U.S. patent application Ser. No. 10/500,699, filed Jul. 2, 2004, incorporated by reference herein in its entirety and relied upon, which is the United States national stage of PCT International Application No. PCT/FR03/00083, filed Jan. 13, 2003.

The invention relates to a novel use of zinc sulphide as agent for combating acarids. The invention also relates to compositions with acarid-combating properties comprising zinc sulphide as additive, in particular polymeric compositions, and to yarns, fibres, filaments and articles obtained from these compositions; it is also targeted at liquid or solid compositions for cleaning and/or treating textile surfaces, in particular carpets, including fitted carpets.

Acarids are harmful not only to agriculture, gardens or forestry but also to man. They can result in particular in allergies, asthma, rhinitis or conjunctivitis in the latter. In the human habitat, for example, acarids are present in a not insignificant amount, in particular in carpets, including fitted carpets, furniture, surface coverings, sofas, curtains, bedding, or mattresses and pillows. Attempts are therefore being made in numerous applications, such as the textile field, to limit the spread of acarids in textile surfaces, for example with the purpose of preventing ailments in man due to acarids. In the medical sectors, it is also of great importance to limit the spread of acarids on operating equipment, building materials or clothes.

Organic insecticidal and acaricidal compositions are known, in particular in the field of agriculture. Such compositions are, for example, disclosed in Patent FR 2 710 239. These compositions can be applied by spraying, by vaporization, by dusting, by spreading of granules and by fumigation, directly or using equipment, over harmful insects and acarids or over the sites where the harmful insects and acarids are present.

Other agents which exhibit biocidal properties have been known for a very long time and used, for example, for cosmetic applications or for fungicidal applications. Among these agents, components based on metals, such as silver, copper or zinc, are those well known.

Numerous finishes comprising bioactive compounds have been developed in order to confer biocidal properties on textile surfaces. However, these finishes always have a limited strength and their effects disappear after one or more washings. It is therefore in numerous cases more advantageous to introduce the active principle directly into the article which has to exhibit a bioactive property.

To this end, it is known to introduce a bioactive agent into yarns spun in solution or spun by coagulation. The bioactive agent is then introduced into the solvent of the polymer.

Commercial organic agents for combating acarids are also known. Mention may be made, for example, of benzylbenzoate, permethrin or 3-iodo-2-propynyl butylcarbamate, sold by Troy under the reference Kertex 100. However, these agents cannot be introduced into thermoplastic polymers since they do not withstand the temperatures for forming the latter or can be converted at these temperatures.

Other bioactive agents which can be incorporated in thermoplastic polymers have been developed. Patent Application WO 01/11956 discloses, for example, the use of a complex formed from dendritic polymer and from biocidal compound based on at least one biocidal metal or metal ion. This complex can be introduced into the molten thermoplastic polymer.

For the polymers formed in the molten phase, the introduction is known of inorganic fillers supporting an element based on a bioactive metal. These fillers can be introduced during the polymerization process or during the forming process. A great many solutions have been provided for the preparation of inorganic fillers. These fillers have to exhibit a satisfactory dispersibility in the polymer and an acceptable colour and they must not have an excessively detrimental effect on the properties of the polymers. Mention may be made as example of inorganic filler for combating acarids of a glass filled with boric acid sold by Ishisuka Glass under the reference Segurocera.

There is a constant search for novel charges for combating acarids which are inexpensive and easy to employ in polymeric compositions, in particular.

Thus, zinc sulphide, an inorganic filler known as such, for example as matifying agent for textile yarns obtained by spinning polymeric compositions, also exhibits properties for combating acarids and their desired properties with regard to cost, ease of use and introduction into polymeric matrices: this is because it easily disperses in these matrices and it withstands their forming temperatures and is not altered at these temperatures.

A first subject-matter of the present invention is therefore the novel use of zinc sulphide as agent for combating acarids.

In a second subject-matter, the invention also relates to compositions with acarid-combating properties comprising zinc sulphide and as additive, for example liquid or solid compositions for cleaning and/or treating textile surfaces (carpets including fitted carpets, in particular) or polymeric compositions.

Finally, in a third subject-matter, the invention relates to yarns, fibres, filaments and articles obtained from the compositions described above. These yarns, fibres, filaments and articles exhibit very good permanent acarid-combating properties.

The zinc sulphide of the invention can be provided in various forms: it can, for example, be a zinc sulphide particle or a partial or complete coating of zinc sulphide on a particle which is different in nature, such as an inorganic particle of silica or of titanium dioxide, and the like. The zinc sulphide, when it is in the form of an essentially spherical particle, can have a small diameter, of the order of 0.3 μm, which allows it to be used in textile yarns, fibres or filaments, in particular. The size of the particles of zinc sulphide according of the invention is not limited and can range up to several millimetres. The zinc sulphide can also be provided in the form of platelets.

Acarids belong to the group of arthropods divided into subclasses: insects and arachnids. Acarids are arachnids and are often parasites and pathogens. There are a large number, several tens of thousands, of known acarids, a very limited number of which are harmful to man. Acarids have a size of 200 to 500 microns and are virtually invisible to the eye. They live essentially in a moist atmosphere (65 to 80% relative humidity) under dark conditions and at ideal mean temperatures of 15 to 25° C. Their life span is +/−3 months.

Mention may be made, as species of acarids, of, for example, the species of the genera Acarus, Tyrophagus and others. The species Dermatophagoides is present in particular in house dust and thus relates more particularly to harmful effects on man. Two varieties of Dermatophagoides are encountered D. pteronyssinus and D. farinae. Acarids of the species Dermatophagoides feed mainly on human skin scales and on waste from the nails or hair, including body hair, on remnants of food, and the like. The present invention is concerned more particularly with the species of the Dermatophagoides.

According to the first subject-matter of the invention, the zinc sulphide can be introduced into any environment comprising acarids in order to reduce or eliminate the amount of acarids present in the environment. The term “environment” is understood to mean any medium comprising at least acarids. The environment can be a gas, preferably air.

The term “to reduce” is understood to mean to decrease the amount of acarids present in the environment, compared with the amount present in the environment before the introduction into the environment of the zinc sulphide. The term “to reduce” is also understood to mean to reduce the rate of growth of new acarids over time and in the environment. The term “to reduce” is also understood to mean to reduce the rate of reproduction of the acarids. The term “to eliminate” is understood to mean to eliminate from the environment most of the acarids, that is to say to kill the acarids present in the environment (acaricide) or to render them inactive. The term “to eliminate” is also understood to mean to prevent the growth of new acarids.

The zinc sulphide of the first subject-matter of the invention can be used as it is, that is to say alone, but it is preferably supported by various inactive supports in the liquid, solid or gas form. Furthermore, additives, such as a surfactant, a dispersant, an adhesive, a stabilizer or propellants, can be added, if necessary, to prepare formulations, such as powders for dusting, granules, emulsions, solutions in an oil, wettable powders, sols, flowing compositions, aerosols, coating agents, fumigants, fuming agents and ULV formulations (formulations for agents at an ultimate low volume).

The amount of zinc sulphide of the first subject-matter of the invention applied can vary with the formulation form and with the time and the date, the site and the method of application, the nature of the harmful organisms and the degree of injury.

The application of the zinc sulphide of the first subject-matter of the invention can be carried out, for example, by spraying, by vaporization, by dusting, by spreading granules and by fumigation, directly or using equipment, over harmful acarids or over the sites where harmful acarids are spreading.

The zinc sulphide of the invention, as agent for combating acarids, can also be employed in any composition and in particular in any composition or product used in the field of textile yarns, fibres, filaments and articles. It can in particular be employed in polymeric compositions and in cleaning and/or treating compositions for textile surfaces, in particular carpets, including fitted carpets.

Thus, the second subject-matter of the invention relates to compositions with acarid-combating properties comprising zinc sulphide as additive and in particular to polymeric compositions, as well as to cleaning and/or treating compositions for textile surfaces, in particular carpets, including fitted carpets.

The zinc sulphide as agent for combating acarids can be used as additive, for example in formulations for the sizing of yarns, fibres and filaments, in finish or paint formulations applied to textile surfaces, in detergent formulations, such as washing compositions for textile surfaces (in particular for carpets, including fitted carpets), in adhesives used, for example, for the manufacture of fitted carpets or coverings, in backings for textile surfaces, and the like.

According to a specific embodiment of the second subject-matter of the invention, the proportion by weight of zinc sulphide with respect to the total weight of the composition is less than or equal to 5%.

According to a first preferred embodiment of the second subject-matter of the invention, the composition is a liquid or solid composition for cleaning and/or treating textile surfaces, in particular carpets, including fitted carpets.

The said compositions can comprise from 0.05 to 5% of their dry weight of zinc sulphide.

When they are liquid compositions, they additionally comprise water and optionally at least one organic solvent. The amount of water can represent at least 10%, preferably at least 50%, of the weight of the composition; this amount of water can range up to 98% of the weight of the composition.

Mention may be made, among the organic solvents, of aliphatic or aromatic alcohols or glycol ethers (methanol, ethanol, propanol, isopropanol, propanediol, ethylene glycol, glycerol, benzyl alcohol, butoxy propoxy propanol, and the like), as well as “degreasing” solvents, such as terpenes. These solvents can represent from 0.1 to 50% of the weight of the liquid composition.

The liquid compositions can additionally comprise other conventional additives employed in liquid cleaning compositions for textile surfaces, in particular carpets, including fitted carpets.

Mention may in particular be made of:
anionic surface-active agents (alkyl ester sulphonates, alkyl sulphates, alkylamide sulphates, salts of saturated or unsaturated fatty acids, and the like), nonionic surface-active agents (polyalkoxylated derivatives of alkylphenols, of fatty acids, of amines, of fatty acid amides or of amidoamines, condensates of ethylene oxide or propylene oxide with ethylenediamine, alkylpolyglucosides, and the like), amphoteric surface-active agents (alkyl amphoacetates, and the like) or zwitterionic surface-active agents (betaines); they can represent from 1 to 20%, preferably from 5 to 15%, of the weight of the liquid composition;
inorganic builders (polyphosphates, silicates, carbonates, zeolites, and the like) or organic chelating or sequestering builders (water-soluble polyphosphonates, carboxylic polymers or copolymers or their water-soluble salts, polycarboxylic acids or their water-soluble salts, salts of polyacetic acids, and the like); it can represent from 5 to 80% of the weight of the liquid composition;
soil-release agents (cellulose derivatives, polyester copolymers based on ethylene terephthalate and polyoxyethylene terephthalate units, sulphated polyester oligomers or copolymers, and the like); they can represent from 0.01 to 10%, preferably from 0.1 to 5%, of the weight of the liquid composition;
bleaching agents (hydrogen peroxide);
agents for inhibiting colour transfer (polyamines N-oxide, or copolymers of N-vinylpyrrolidone and of N-vinylimidazole);
foam suppressants;
propellants (isobutane, propane, and the like);
and other additives, such as enzymes, buffers, fillers, fragrances, and the like.

When they are solid compositions for cleaning and/or treating textile surfaces, they additionally comprise at least one filler which can represent from 40 to 98.5% of the weight of the solid composition.

These fillers are in particular of borax type, preferably sodium borate decahydrates, in particular sodium tetraborate decahydrate; they can also be inorganic salts, such as sulphates, chlorides, carbonates, bicarbonates, phosphates or nitrates, or sodium in particular, aluminium salts, such as sodium aluminate, and sodium citrate.

The solid compositions can additionally comprise other conventional additives employed in solid cleaning compositions for textile surfaces, in particular carpets, including fitted carpets.

Mention may in particular be made of:
adsorbents, such as cellulose powders, polyurethane foams or bentonite;
alcohol ethers, such as ethylene glycol monomethyl ether, diethylene glycol monomethyl ether, propylene glycol monomethyl ether, dipropylene glycol monomethyl ether, ethylene glycol monoethyl ether, diethylene glycol monoethyl ether or ethylene glycol monobutyl ether;
anionic, nonionic, cationic or amphoteric surface-active agents in the liquid or solid form, such as those described above;
antistatic agents, such as aluminium oxides, quaternary ammonium salts, ethoxylated alcohols, alkylphenols, ethoxylated amines, anionic soaps, sulphates or sulphonates;
agglomerating agents.

The compositions for cleaning and/or treating textile surfaces can be deposited on the surface to be treated by different methods:
machine with a high steam throughput: expulsion of hot steam under high pressure, spraying over the fitted carpet and then vacuum suction.
direct impregnation of the cleaning formulation over the surface to be treated, with optional rubbing using a sponge or a brush. The product can subsequently be removed by absorption on an absorbent or by vacuum suction.
spraying of the cleaning formulation over the fitted carpet in the form of fine drops. The product can optionally be dried by passing hot air, the solids deposited subsequently being removed by suction or brushing.
application using a carpet shampooer.

The liquid compositions can optionally be diluted with water before use.

The compositions for cleaning and/or treating textile articles can be employed in amounts, expressed on a dry basis, of 0.01 to 200 mg/m² of surface area to be treated.

According to a second preferred embodiment of the second subject-matter of the invention, the composition is a polymeric composition.

The polymeric composition of the invention comprises a polymeric matrix. Any polymeric matrix known to a person skilled in the art can be employed in the context of the present invention.

The polymeric matrix of the invention is preferably a thermoplastic matrix. The thermoplastic matrix in accordance with the invention is a thermoplastic polymer.

Mention is made, as examples of polymers which may be suitable, of: polylactones, such as poly(pivalolactone), poly(caprolactone) and polymers of the same family; polyurethanes obtained by reaction between diisocyanates, such as 1,5-naphthalene diisocyanate, p-phenylene diisocyanate, m-phenylene diisocyanate, 2,4-toluene diisocyanate, 4,4′-diphenyl-methane diisocyanate, 3,3′-dimethyl-4,4′-diphenyl-methane diisocyanate, 3,3′-dimethyl-4,4′-biphenyl diisocyanate, 4,4′-diphenylisopropylidene diisocyanate, 3,3′-dimethyl-4,4′-diphenyl diisocyanate, 3,3′-dimethyl-4,4′-diphenylmethane diisocyanate, 3,3′-dimethoxy-4,4′-biphenyl diisocyanate, dianisidine diisocyanate, toluidine diisocyanate, hexamethylene diisocyanate, 4,4′-diisocyanatodiphenylmethane and compounds of the same family, and diols with long linear chains, such as poly(tetramethylene adipate), poly(ethylene adipate), poly(1,4-butylene adipate), poly(ethylene succinate), poly(2,3-butylene succinate), polyether diols and compounds of the same family; polycarbonates, such as poly[methanebis(4-phenyl)-carbonate], poly[1,1-etherbis(4-phenyl)carbonate], poly[diphenylmethanebis(4-phenyl)carbonate], poly[1,1-cyclohexanebis(4-phenyl)carbonate] and polymers of the same family; polysulphones; polyethers; polyketones; polyamides, such as poly(4-aminobutyric acid), poly(hexamethylene adipamide), poly(6-aminohexanoic acid), poly(m-xylylene adipamide), poly(p-xylylene sebacamide), poly(2,2,2-trimethylhexamethylene terephthalamide), poly(meta-phenylene isophthalamide), poly(p-phenylene terephthalamide) and polymers of the same family; polyesters, such as poly(ethylene azelate), poly(ethylene 1,5-naphthalate), poly(1,4-cyclohexanedimethylene terephthalate), poly(ethylene oxybenzoate), poly([lacuna]para-hydroxybenzoate), poly(1,4-cyclohexylidenedimethylene terephthalate), polyethylene terephthalate, polybutylene terephthalate and polymers of the same family; poly(arylene oxides), such as poly(2,6-di-methyl-1,4-phenylene oxide), poly(2,6-diphenyl-1,4-phenylene oxide) and polymers of the same family; poly(arylene sulphides), such as poly(phenylene sulphide) and polymers of the same family; polyetherimides; vinyl polymers and their copolymers, such as polyvinyl acetate, polyvinyl alcohol, polyvinyl chloride, polyvinylbutyral, polyvinylidene chloride, ethylene-vinyl acetate copolymers and polymers of the same family; acrylic polymers, polyacrylates and their copolymers, such as polyethyl acrylate, poly(n-butyl acrylate), polymethyl methacrylate, polyethyl methacrylate, poly(n-butyl methacrylate), poly(n-propyl methacrylate), polyacrylamide, polyacrylonitrile, poly(acrylic acid), ethylene-acrylic acid copolymers, ethylene-vinyl alcohol copolymers, acrylonitrile copolymers, methyl methacrylate-styrene copolymers, ethylene-ethyl acrylate copolymers, methacrylate-butadiene-styrene copolymers, ABS and polymers of the same family; polyolefins, such as low density poly(ethylene), poly(propylene), low density chlorinated poly(ethylene), poly(4-methyl-1-pentene), poly(ethylene), poly(styrene) and polymers of the same family; ionomers; poly(epichlorohydrins); poly(urethane)s, such as polymerization products of diols, such as glycerol, trimethylolpropane, 1,2,6-hexanetriol, sorbitol, pentaerythritol, polyetherpolyols, polyesterpolyols and compounds of the same family, with polyisocyanates, such as 2,4-tolylene diisocyanate, 2,6-tolylene diisocyanate, 4,4′-di-phenylmethane diisocyanate, 1,6-hexamethylene diisocyanate, 4,4′-dicyclohexylmethane diisocyanate and compounds of the same family; polysulphones, such as the products of reaction between a sodium salt of 2,2-bis(4-hydroxyphenyl)propane and 4,4′-dichloro-diphenyl sulphone; furan resins, such as poly(furan); cellulose ester plastics, such as cellulose acetate, cellulose acetate butyrate, cellulose propionate and polymers of the same family; silicones, such as poly(dimethylsiloxane), poly(dimethylsiloxane-co-phenylmethylsiloxane) and polymers of the same family; or blends of at least two of the above polymers.

According to a specific alternative form of the invention, the thermoplastic matrix is a polymer comprising star-shaped or H-shaped macromolecular chains and, if appropriate, linear macromolecular chains. The polymers comprising such star-shaped or H-shaped macromolecular chains are disclosed, for example, in the documents FR 2 743 077, FR 2 779 730, U.S. Pat. No. 5,959,069, EP 0 632 703, EP 0 682 057 and EP 0 832 149.

According to another specific alternative form of the invention, the thermoplastic matrix of the invention is a polymer of random tree type, preferably a copolyamide exhibiting a random tree structure. These copolyamides with a random tree structure and their process of preparation are disclosed in particular in the document WO 99/03909.

The thermoplastic matrix of the invention can also be a composition comprising a linear thermoplastic polymer and a star-shaped, H-shaped and/or random tree thermoplastic polymer as are described above.

The compositions of the invention can also comprise a hyperbranched copolyamide of the type of those disclosed in the document WO 00/68298.

The compositions of the invention can also comprise any combination of star-shaped, H-shaped or random tree thermoplastic polymer or hyperbranched copolyamide described above.

Mention may be made, as other type of polymeric matrix which can be employed in the context of the invention of thermally stable polymers: these polymers are preferably infusible or exhibit a softening point of greater than 180° C., preferably >200° C., or greater. These thermally stable polymers can, for example, be chosen from aromatic polyamides, polyamideimides, such as polytrimellamideimides, or polyimides, such as the polyimides obtained according to the document EP 0 119 185, known commercially under the P84 trade name. The aromatic polyamides can be as disclosed in Patent EP 0 360 707. They can be obtained according to the process disclosed in Patent EP 0 360 707.

Mention may also be made, as other polymeric matrix, of viscose, cellulose, cellulose acetate, and the like.

The polymeric matrix of the invention can also be of the type of the polymers used in adhesives, such as vinylacetate copolymer plastisols, acrylic latices, urethane latices, PVC plastisols, and the like.

Preference is very particularly given, among these polymeric matrices, to semicrystalline polyamides, such as polyamide 6, polyamide 6,6, polyamide 11, polyamide 12, polyamide 4, polyamides 4,6, 6,10, 6,12, 6,36 or 12,12, or semiaromatic polyamides obtained from terephthalic and/or isophthalic acid, such as the polyamide sold under the trade name Amodel; polyesters, such as PET, PBT or PTT; polyolefins, such as polypropylene or polyethylene; aromatic polyamides, polyamideimides or polyimides; the latices, such as acrylic and urethane latices; PVC, viscose, cellulose or cellulose acetate; or their copolymers and alloys.

The compositions can comprise any other additive which can be used, for example reinforcing fillers, flame-retardants, UV stabilizers, heat stabilizers or matifying agents, such as titanium dioxide.

The third subject-matter of the invention relates to the yarns, fibres, filaments and articles obtained from the compositions and in particular the polymeric compositions described above.

This is because the compositions, in particular polymeric compositions, according to the invention can be formed into yarns, fibres and filaments by spinning. They can also be formed into moulded forms, for example by injection moulding or by extrusion.

The yarns, fibres and filaments of the invention can be obtained, for example, by melt spinning or by wet spinning the compositions, in particular polymeric compositions, of the invention.

The polymeric compositions are preferably prepared by introducing the zinc sulphide into the molten polymer in a blending device, for example upstream of a spinning device. They can also be prepared by introducing the zinc sulphide into a polymer solution, for example upstream of a device for wet spinning. They can also be prepared by introducing the zinc sulphide into the reaction medium comprising the monomers from which the polymer is formed (polymerization medium).

By spinning the compositions, in particular polymeric compositions, of the invention, it is possible to obtain, for example, continuous multifilament yarns, short or long fibres, monofilaments, spun yarns for fibres, laps, slivers, tows, and the like. The product obtained can also be bulk continuous filaments (BCF), used in particular for the manufacture of textile coverings, such as carpets, including fitted carpets.

All the conventional treatments in the textile field can be applied to the yarns, fibres and filaments of the invention, such as drawing, texturing, dyeing, and the like.

In the field of textile yarns, fibres or filaments, the small size of the zinc sulphide particles, the diameter of which can be of the order of 0.3 μm, is an advantage in spinning processes in particular.

The yarns, fibres and filaments described above exhibit permanent acarid-combating properties.

The invention also relates to articles obtained from the yarns, fibres or filaments described above. Such articles can be obtained in particular from a single type of yarn, fibre or filament or, in contrast from a mixture of yarns, fibres or filaments of different types. The article comprises at least in part yarns, fibres or filaments according to the invention. For a given type of yarn, fibre or filament, for example yarns, fibres or filaments not comprising zinc sulphide, yarns, fibres or filaments of different natures can be used in the article of the invention.

Mention may be made, as articles, for example, of woven, nonwoven or knitted articles.

The present invention also relates to composite textile articles, that is to say textile articles comprising several components. These components can be, for example, short fibres, backings, adhesives, articles obtained from yarns, fibres or filaments, such as nonwoven articles, and the like.

Mention may be made, as composite textile articles of, for example, flocked surfaces, the main components of which are generally short fibres, an adhesive, and a backing.

Mention may also be made of tufted surfaces, used in particular in fitted carpets, coverings for furniture or walls, and the like, the main components of which are generally yarns, fibres, filaments or articles obtained from yarns, fibres or filaments, a backing and optionally an adhesive.

In the context of the invention, at least one of the components of the composite textile article comprises zinc sulphide.

In a flocked surface, for example, the zinc sulphide can be present in the fibres of the flocked surface and/or in the adhesive used for the flocking and/or in the backing of the flocked surface.

The fibres of a flocked surface can, for example, be fibres according to the invention. The adhesive or the glue of a flocked or tufted surface can be obtained from a composition according to the invention. The backing of a flocked or tufted surface can also be obtained from a composition or an article according to the invention.

The textile articles described above exhibit permanent acarid-combating properties.

The compositions, yarns, fibres, filaments, articles and composite textile articles can be employed in the manufacture of any product likely to be in contact with acarids, such as carpets, including fitted carpets, furniture coverings, surface coverings sofas, curtains, bedding, mattresses and pillows, and the like.

The compositions, yarns, fibres, filaments, articles and composite textile articles of the invention preferably make possible a regulation of the population of the acarids CP, as defined in Example 12, 13 or 14, after 6 weeks at least equal to 50, the CP being measured according to the AFNOR standard NF G 39-011. The measuring method used is one of the methods described in Example 12, 13 or 14, the method being defined according to the nature of the type of product to be tested (composition, powder, knitted fabric, fitted carpet, and the like).

Other details and advantages of the invention will become more clearly apparent in the light of the examples below, given solely by way of indication.

### EXAMPLES

### Example 1-7

### Preparation of Polyamide 6,6, Polyamide 6, Polypropylene or Polyester Powder Samples, to which ZnS May or May not have been Added

### PA 6,6 Matrix

The polyamide 6,6, recorded as PA 6,6, employed is a polyamide 6,6 which does not comprise titanium dioxide and which has a relative viscosity of 2.5 (measured at a concentration of 10 g/l in 96% sulphuric acid).

Two types of ZnS were used:
ZnS 1: ZnS with a particle size centred around 0.3 μm and exhibiting a purity of 98%.
ZnS 2: ZnS with a particle size centred around 2.6 μm and exhibiting a purity of 99.99%, sold by Aldrich under the reference 24462-7.

The incorporation of the ZnS in the PA 6,6 is carried out by blending powders. The blend is dried at 80° C. for 16 h under a vacuum of approximately 50 mbar and is then introduced into an extrusion device which provides melt blending. The operating characteristics of the extruder are as follows:
Temperature of the melt: approximately 285° C.
Residence time in the melt: 3 minutes

The lace obtained at the outlet of the extrusion device is quenched in water at approximately 20° C. and then crushed and milled, after cooling with dry ice, with a Retsch ZM 1000 ultracentrifugal mill.

The particle size of the powder obtained is less than 500 μm.

The following compositions were prepared.

The level of ZnS is expressed as weight of ZnS with respect to the total weight of the composition.

| Reference | Level of ZnS 1 (% w/w) | Level of ZnS 2 (% w/w) |
|---|---|---|
| 1-a1 | 0 | 0 |
| 1-b1 | 0.5 | 0 |
| 1-c1 | 1 | 0 |
| 1-a2 | 0 | 0 |
| 1-b2 | 0 | 0.5 |
| 1-c2 | 0 | 1 |

### PA 6 Matrix

Two types of polyamide 6, recorded as PA 6, were used:
PA 6-1: PA 6 which does not comprise titanium dioxide and which has a relative viscosity of 2.5 (measured at a concentration of 10 g/l in 96% sulphuric acid).
PA 6-2: Polyamide 6 which comprises 0.3% of TiO₂ and which has a relative viscosity of 2.7 (measured at a concentration of 10 g/l in 96% sulphuric acid).

The ZnS used is ZnS 1.

The incorporation of the ZnS in these PA 6 types is carried out in the same way as in Example 1.

The operating characteristics of the extruder are as follows:
Temperature of the melt: approximately 240° C.
Residence time in the melt: 3 minutes

The lace obtained at the outlet of the extrusion device is quenched in water at approximately 20° C. and then crushed and milled, after cooling with dry ice, with a Retsch ZM 1000 ultracentrifugal mill.

The particle size of the powder obtained is less than 500 μm.

The following compositions were prepared.

The level of ZnS is expressed as weight of ZnS with respect to the total weight of the composition.

| Reference | PA 6 matrix | Level of ZnS (% w/w) |
|---|---|---|
| 2-a | PA 6-1 | 0 |
| 2-b | PA 6-1 | 0.5 |
| 2-c | PA 6-1 | 1 |
| 3-a | PA 6-2 | 0 |
| 3-b | PA 6-2 | 0.5 |
| 3-c | PA 6-2 | 1 |

Blends were also prepared using PA 6-1, 0.5% by weight of ZnS 1 and a given percentage of conventional pigments and stabilizer.

The stabilizer used is incorporated in the form of a PA 6 masterbatch comprising 10% by weight of blend of KI and CuI.

The various pigments used are also incorporated in the form of a masterbatch, the characteristics of which are as follows:
Black pigment: PA 6 masterbatch comprising 20% of pigment (ref. Sandofil MP-HPLA-AN FG from Clariant)
Purple pigment 1: PA 6 masterbatch comprising 25% of pigment (ref. Sandofil MP-BPL FG from Clariant)
Brown pigment: PA 6 masterbatch comprising 50% of pigment (ref. Sandofil MP-2GL-AN FG from Clariant)
Yellow pigment: PA 6 masterbatch comprising 25% of pigment (ref. Sandofil MP-2G AN FG from Clariant)
Blue pigment: PA 6 masterbatch comprising 20% of pigment (ref. Sandofil MP-2GLS AN FG from Clariant)
Red pigment: PA 6 masterbatch comprising 25% of pigment (ref. Sandofil MP-G-AN FG from Clariant)

The incorporation of the ZnS, the stabilizer and the pigments in the PA 6 is carried out by blending powders, in the same way as in Example 1, and the blend is extruded with the same operating conditions as in Examples 2 and 3, with PA 6 as matrix.

The following compositions were prepared (PA 6-1 base+0.5% ZnS 1)

| | | | Pigment masterbatch | |
|---|---|---|---|---|
| | | Level of | | Level of |
| | ZnS | stabilizer | | pigment |
| | level | masterbatch | Nature of | masterbatch |
| Reference | (% w/w) | (% w/w) | the pigment | (% w/w) |
| 4-a1 | 0 | 0 | — | 0 |
| 4-a2 | 0.5 | 0 | — | 0 |
| 4-b1 | 0 | 0.2 | black pigment | 1.6 |
| 4-b2 | 0.5 | 0.2 | black pigment | 1.6 |
| 4-c1 | 0 | 0.2 | purple pigment 1 | 1.5 |
| 4-c2 | 0.5 | 0.2 | purple pigment 1 | 1.5 |
| 4-d1 | 0 | 0.2 | brown pigment | 2.0 |
| 4-d2 | 0.5 | 0.2 | brown pigment | 2.0 |
| 4-e1 | 0 | 0.2 | yellow pigment | 6.0 |
| 4-e2 | 0.5 | 0.2 | yellow pigment | 6.0 |
| 4-f1 | 0 | 0.2 | blue pigment | 2.3 |
| 4-f2 | 0.5 | 0.2 | blue pigment | 2.3 |
| 4-g1 | 0 | 0.2 | red pigment | 3.5 |
| 4-g2 | 0.5 | 0.2 | red pigment | 3.5 |

### Polypropylene Matrix

The polypropylene, recorded as PP, employed is the reference Pro-Fax 6301, sold by Basell. The ZnS used is ZnS 1.

The incorporation of the ZnS in the PP is carried out in the same way as in Example 1 but the blend is not dried before extrusion but is simply stored in a dessicator under P₂O₅. The operating characteristics of the extruder are specified below:
Temperature of the melt: approximately 210° C.
Residence time in the melt: 3 minutes

For the milling stage, the blend is cooled with dry ice and liquid nitrogen.

The following compositions were prepared.

The level of ZnS is expressed as weight of ZnS with respect to the total weight of the composition.

| Reference | Level of ZnS (% w/w) |
|---|---|
| 5-a | 0 |
| 5-b | 0.5 |
| 5-c | 1 |

### Polyester Matrix

Two polyester matrices, recorded as PET, were employed:
PET 1: PET which does not comprise titanium dioxide and which has a viscosity index of 83.6 (measured at a concentration of 5 g/l in a 50/50 w/w mixture of phenol and dichlorobenzene).
PET 2: PET which comprises 0.4% of titanium dioxide and which has a viscosity index of 74.6 (measured at a concentration of 5 g/l in a 50/50 w/w mixture of phenol and dichlorobenzene).

The ZnS used is ZnS 1.

The incorporation of the ZnS in the PET is carried out in the same way as in Example 1 but the blend is dried at 150° C. for 16 h under a vacuum of approximately 50 mbar. The operating characteristics of the extruder are specified below:
Temperature of the melt: approximately 280° C.
Residence time in the melt: 3 minutes

The following compositions were prepared.

The level of ZnS is expressed as weight of ZnS with respect to the total weight of the composition.

| Reference | PET matrix | Level of ZnS (% w/w) |
|---|---|---|
| 6-a | PET 1 | 0 |
| 6-b | PET 1 | 0.5 |
| 6-c | PET 1 | 1 |
| 7-a | PET 2 | 0 |
| 7-b | PET 2 | 0.5 |
| 7-c | PET 2 | 1 |

### Example 8

### Preparation of Yarns Formed from Polyamide 6,6, to which ZnS May or May not have been Added, and Preparation of Knitted Surfaces

### Preparation of the Yarns

The polyamide 6,6 employed is a polyamide 6,6 which not does not comprise titanium dioxide and which has a relative viscosity of 2.5 (measured at a concentration of 10 g/l in 96% sulphuric acid). The ZnS used is ZnS 1. The incorporation of the ZnS in the PA 6,6 is carried out by blending powders and then in the molten phase using an extrusion device. The melt blend is subsequently spun with a spinneret head temperature of approximately 285° C., cooled with air (20° C., 66% relative humidity) and forwarded with a velocity at the first forwarding point of 4 200 m/min, so as to obtain a continuous multifilament yarn of 42 dtex per 10 filaments. The multifilament or yarn is composed of 10 strands and the diameter of the strand is approximately 20 μm.

The following compositions were prepared.

The level of ZnS is expressed as weight of ZnS with respect to the total weight of the composition.

| Reference | Level of ZnS (% w/w) |
|---|---|
| 8-a | 0 |
| 8-b | 1 |
| 8-c | 2 |

### Characterization of the Samples

The properties of the strands obtained are specified below:
Elongation at break: 80 to 85% (according to the standard ISO 2062)
Fracture toughness: 22 to 24 cN/tex (according to the standard ISO 2062)

### Preparation of the Knitted Fabrics

The preparation of the knitted surfaces is carried out by single-feeder knitting. Socks with a diameter of approximately 8 cm having a weight per unit of surface area of approximately 35 g/m² are obtained. The numbering of the raw knitted fabrics is identical to that of the yarns: from 8-a to 8-c.

### Example 9

### Preparation of Yarns Made of Polyamide 6,6, to which ZnS May or May not have been Added, and Preparation of Knitted Surfaces

### Preparation of Yarns

The polyamide 6,6 employed is a polyamide 6,6 which not does not comprise titanium dioxide and which has a relative viscosity of 2.6 (measured at a concentration of 10 g/l in 96% sulphuric acid). The ZnS is introduced in the form of a masterbatch. The masterbatch is composed of ZnS 1 introduced at 40% by weight into PA 6 with a relative viscosity of 2 (measured at a concentration of 10 g/l in 96% sulphuric acid).

It is introduced into the PA 6,6 in an extruder using a gravimetric metering device. The melt blend is subsequently spun with a spinneret head temperature of approximately 286° C., cooled with water and forwarded with a velocity at the first forwarding point of 600 m/min, then drawn with a draw ratio of approximately 2.7, so as to obtain a continuous multifilament yarn of 1250 dtex per 68 filaments. The multifilament or yarn is composed of 68 strands and the diameter of the strand is approximately 43 μm.

The following compositions were prepared.

The level of ZnS is expressed as weight of ZnS with respect to the total weight of the composition.

| Reference | Level of ZnS (% w/w) |
|---|---|
| 9-a | 0 |
| 9-b | 0.2 |
| 9-c | 1 |

By way of comparison, a yarn of 1250 dtex per 68 filaments comprising 0.3% of TiO₂ was added to the series; it will be numbered 9-e.

### Characterization of the Samples

The properties of the yarns obtained are specified below:
Elongation at break: 40 to 44% (according to the standard ISO 2062)
Fracture toughness: 20 to 21 cN/tex (according to the standard ISO 2062)

### Preparation of the Knitted Fabrics

The preparation of the knitted surfaces is carried out by single-feeder knitting. Socks with a diameter of approximately 6 cm with a weight per unit of surface area of approximately 300 g/m² are obtained. The numbering of the raw knitted fabrics is identical to that of the yarns: from 9-a to 9-c.
The knitted fabrics were subsequently dyed in softened water at pH 6 with a bath ratio of 1/50, according to a method known to a person skilled in the art.

Two different dyes were used:
Dye 1: acid dye Acid Blue 80®, sold by CIBA.
Dye 2: metal dye Acid Blue 284®, sold by Yorkshire.

No significant difference in dye uptake was observed between the 5 knitted fabrics.

The samples are then numbered as indicated in the table below.

The level of ZnS is expressed as weight of ZnS with respect to the total weight of the composition.

| | Level of Zns | Level of TiO₂ | |
|---|---|---|---|
| Reference | (% w/w) | (% w/w) | Dye |
| 9-a1 | 0 | 0 | dye 1 |
| 9-b1 | 0.2 | 0 | dye 1 |
| 9-c1 | 1 | 0 | dye 1 |
| 9-d1 | 0 | 0.3 | dye 1 |
| 9-a2 | 0 | 0 | dye 2 |
| 9-b2 | 0.2 | 0 | dye 2 |
| 9-c2 | 1 | 0 | dye 2 |
| 9-d2 | 0 | 0.3 | dye 2 |

### Example 10

### Preparation of Fitted Carpets with the Yarns Obtained According to Example 9

### Preparation of the Yarns for the Tufting

The yarns obtained according to Example 9 were prepared according to the following process: gathering together two 1250/68 yarns by twisting at 220 revolutions/m and heatsetting according to the superba process known to a person skilled in the art.

The following yarns were produced:

| | Reference of the |
|---|---|
| Reference of the | thermoset yarn |
| 1250/68 yarn | for the tufting |
| 9-a | 10-a |
| 9-b | 10-b |
| 9-c | 10-c |
| 9-d | 10-d |

### Preparation of the Fitted Carpets

The yarns obtained above were tufted onto a primary backing composed of a cloth formed from woven PP ribbons (reference: Ribbon 9020FS®, sold by Carpet Backing, Italy). A saxony velvet tuft was produced. The gauge is 1/10″, with 50 stitches per 10 cm, a carpet height of approximately 6 mm and a weight of 820 g of yarns per m².

The tufts obtained above were sometimes dyed according to the following process: 30 min at 98° C., pH 6, with a dye formula composed of monosodium phosphate, Univadine, Tectilon yellow, Tectilon red and Tectilon blue, and then softened (20 minutes at 40° C., a solution of Sandotex CD paste, 0.5%, and a tartaric acid, 0.2 g/l). These raw or dyed tufts were adhesively bonded to a secondary backing composed of a PP cloth (reference 72/730 HF®, sold by Carpet Backing, Italy). The adhesive used is composed of SBS synthetic latices+500 parts by weight of calcium carbonate (reference of the adhesive: Latex VM 612 IM 1201 Polyfass®, sold by Synthomer). It is applied to the primary backing so as to obtain 950 g of adhesive per m² of tuft approximately after drying.

The fitted carpets obtained are as follows:

| Reference of the yarn | | Reference of the |
|---|---|---|
| for the tufting | Dyeing stage | fitted carpet |
| 10-a | no | 10-a1 |
| | yes | 10-a2 |
| 10-b | no | 10-b1 |
| | yes | 10-b2 |
| 10-c | no | 10-c1 |
| | yes | 10-c2 |
| 10-d | no | 10-d1 |
| | yes | 10-d2 |

The fitted carpets are subsequently subjected to washing extraction with water before the activity test.

### Example 11

### Preparation of the Samples of Adhesive for a Fitted Carpet, to which Samples ZnS May or May not have been Added

The adhesive used is composed of SBS synthetic latices+500 parts by weight of calcium carbonate (reference of adhesive: Latex VM 612®, sold by Synthomer). The ZnS used is ZnS 1; it is introduced into the adhesive in the powder form and then blended with a mixer (Kika Labortechnik) for approximately 5 to 10 min. The adhesive thus obtained is spread over a piece of cardboard in the form of a disc with a diameter of 8 cm and a thickness of 2 to 3 mm.

The following compositions were produced.

The level of ZnS is expressed as weight of ZnS with respect to the total weight of the composition.

| Reference of the adhesive | Level of ZnS (% w/w) |
|---|---|
| 11-a | 0 |
| 11-b | 5 |

### Example 12

### Characterization of the Behaviour with Respect to the Acarids of the Samples of Pure Powders Formed from ZnS or of Powders Obtained According to Examples 1-7

### Principle

This characterization is carried out by a laboratory registered by the French Ministry of Agriculture, Fisheries and Food. The object is to evaluate the effectiveness of PA powders, to which ZnS may or may not have been added, on the regulation of the change in a population of dust mites (dermatophagoides pteronyssinus). Monitoring is carried out over two development cycles of the acarids, i.e. 6 weeks.

### Breeding Source of the Acarids

The acarids used originate from a laboratory strain raised on a substrate composed of a 50/50 (w/w) mixture of wheatgerm and of brewers yeast as specks graded by sieving (fragments of less than 1 mm). The temperature is between 23 and 25° C. and the relative humidity is maintained at 75% by the presence of a saturated ammonium sulphate solution. The screen is kept in darkness.

The screen is supplied by the Laboratoire des Insectes et Acariens des Denrees [Laboratory of the Insects and Acarids of Foodstuff] of the Institut National de Recherches Agronomiques (INRA) [National Institute of Agronomic Research] at Bordeaux, according to the AFNOR standard NF G 39-011.

### Experimental Method

The method is derived directly from the AFNOR standard NF G 39-011, with the following variations:
the experimental unit is composed of a chamber with a diameter of 8 cm which is escapeproof with regard to acarids but which allows ventilation and in which are found:
   5 g of nutrient medium (food 1/NF G 39-011 appendix)
   5 g of test powder, carpeting the bottom of the chamber
the study is carried out by placing 50 acarids in these devices
4 repetitions are carried out on the same day per experimental factor, including for the control batches composed of the same device but without the addition of the powder. The result is expressed in the form of a mean and standard deviation with regard to these 4 samples.

The monitoring consists in counting the number of living acarids after the time period of 6 weeks. As direct counting is rendered impossible by the structure of the substrate, extraction by heat according to the recommendations of the AFNOR standard NF G 39-011 is used.

The criterion of effectiveness of an additive is then defined as the coefficient of regulation of the population of acarids (CP), i.e.:

$$C P = \frac{( \begin{matrix}Population on the powder without the additive - \\ population on the powder with the additive\end{matrix} )}{Population on the powder without the additive} \times 100$$

The population counts are all carried out at 6 weeks.

The CP interpretation is as follows:
the closer CP is to 0, the less effective the addition, since the population on the sample with the additive will increase at the same rate as that on the sample without the additive;
the closer CP is to 100, the more effective the addition in having eradicated the population of acarids and having checked its process of expansion.

### Experimental Results

The data for the various experimental series are summarized in the following tables:

### Pure Powders for ZnS

Pure powders were tested:
ZnS 1 powder
ZnS 2 powder

In this case, the growth control for the acarids is nonextruded PA 6,6. The results are as follows.

| | |
|---|---|
| Number of living acarids | |
| after 6 weeks | CP |

| Reference | Mean | Standard deviation | Mean |
|---|---|---|---|
| Nonextruded PA 6,6 | 864 | 91 | |
| ZnS 1 | 318 | 31 | 63 |
| ZnS 2 | 305 | 30 | 65 |

The natural expansion of the acarids on the powder without the additive validates the tests insofar as this confirms the extremely favourable conditions to which the powders are subjected: this is because the populations of acarids not subjected to the additive have a growth factor of more than 15.

In both cases, the ZnS results in regulation of the population of the acarids.

### Powders Obtained According to Example 1: Pa 6,6 Matrix

The results are as follows.

| | |
|---|---|
| Number of living acarids | |
| after 6 weeks | CP |

| Reference | Mean | Standard deviation | Mean |
|---|---|---|---|
| 1-a1 | 939 | 65 | |
| 1-b1 | 84 | 8 | 91 |
| 1-c1 | 92 | 17 | 90 |
| 1-a2 | 824 | 23 | |
| 1-b2 | 153 | 19 | 81 |
| 1-c2 | 133 | 15 | 84 |

The control for growth of the acarids is in accordance.

The addition of ZnS to PA 6,6 checks the process of expansion of the population of the acarids.

An additional test was carried out on two powders but substituting, during the acarid-combating test, the 5 g of conventional nutrient medium by 200 mg of nutrient medium plus “natural”, composed of 50% w/w of beard hairs washed beforehand with ethanol and of 50% w/w of house dust sieved at 20 μm.

The results are as follows:

| | |
|---|---|
| Number of living acarids | |
| after 6 weeks | CP |

| Reference | Mean | Standard deviation | Mean |
|---|---|---|---|
| 1-a1 | 1017 | 114 | |
| 1-b1 | 196 | 16 | 81 |

The control or growth of the acarids is in accordance.

The acarid-combating activity of the ZnS introduced into the PA 6,6 is re-encountered, even in the presence of a very rich food for the acarids.

### Powders Obtained According to Examples 2 to 4:

### PA 6 Matrix

The results are as follows.

| | |
|---|---|
| Number of living acarids | |
| after 6 weeks | CP |

| Reference | Mean | Standard deviation | Mean |
|---|---|---|---|
| 2-a | 707 | 23 | |
| 2-b | 131 | 10 | 81 |
| 2-c | 124 | 11 | 82 |
| 3-a | 820 | 66 | |
| 3-b | 266 | 36 | 68 |
| 3-c | 244 | 27 | 70 |

| | |
|---|---|
| Number of living acarids | |
| after 6 weeks | CP |

| Reference | Mean | Standard deviation | Mean |
|---|---|---|---|
| 4-a1 | 707 | 23 | |
| 4-a2 | 131 | 10 | 81 |
| 4-b1 | 610 | 53 | |
| 4-b2 | 200 | 18 | 67 |
| 4-c1 | 782 | 45 | |
| 4-c2 | 205 | 29 | 74 |
| 4-d1 | 800 | 37 | |
| 4-d2 | 146 | 35 | 82 |
| 4-e1 | 847 | 41 | |
| 4-e2 | 114 | 19 | 87 |
| 4-f1 | 730 | 80 | |
| 4-f2 | 210 | 20 | 71 |
| 4-g1 | 749 | 68 | |
| 4-g2 | 211 | 25 | 72 |

The control for growth of the acarids is in accordance with regard to each control.

The addition of ZnS to the PA 6 checks the process of expansion of the population of the acarids, this being the case even in the presence of other additives (TiO₂, stabilizer, pigments).

### Powders Obtained According to Example 5: PP Matrix

The results are as follows.

| | |
|---|---|
| Number of living acarids | |
| after 6 weeks | CP |

| Reference | Mean | Standard deviation | Mean |
|---|---|---|---|
| 5-a | 833 | 55 | |
| 5-b | 359 | 36 | 57 |
| 5-c | 219 | 32 | 74 |

The control for growth of the acarids is in accordance.

The addition of ZnS to the PP checks the process of expansion of the population of the acarids.

### Powders Obtained According to Examples 6 and 7:

### PET Matrix

The results are as follows.

| | |
|---|---|
| Number of living acarids | |
| after 6 weeks | CP |

| Reference | Mean | Standard deviation | Mean |
|---|---|---|---|
| 6-a | 870 | 61 | |
| 6-b | 343 | 27 | 61 |
| 6-c | 186 | 18 | 79 |

| | |
|---|---|
| Number of living acarids | |
| after 6 weeks | CP |

| Reference | Mean | Standard deviation | Mean |
|---|---|---|---|
| 7-a | 870 | 56 | |
| 7-b | 217 | 47 | 75 |
| 7-c | 227 | 36 | 74 |

The control for growth of the acarids is in accordance.

The addition of ZnS to the PET checks the process of expansion of the population of the acarids.

### Example 13

### Characterization of the Behaviour with Respect to the Acarids of Knitted Fabrics Obtained According to Examples 8 and 9, of Fitted Carpets Obtained in Accordance with Example 10 and of Adhesives Obtained According to Example 11

### Experimental Method

This characterization is carried out in the same laboratory which carried out the tests of Example 12. The principle of the characterization and the source of the acarids are identical. The method is similar, except that the experimental unit is composed of a chamber with a diameter of 8 cm which is escapeproof with regard to the acarids but which allows ventilation and in which are found:
5 g of nutrient medium (food 1/NF G 39-011 appendix)
a piece of knitted fabric, of fitted carpet or of adhesive to be tested carpeting the bottom of the chamber.

The method of counting the acarids and the calculation of the coefficient of regulation of the population of acarids (CP) are identical to Example 12.

$$C P = \frac{( \begin{matrix}Population on the piece without the additive - \\ population on the piece with the additive\end{matrix} )}{Population on the piece without the additive} \times 100$$

The population counts are all carried out at 6 weeks.

### Experimental Results

The data for the various experimental series are summarized in the following tables:

### Knitted Fabrics Obtained According to Example 8

The results are as follows.

| | |
|---|---|
| Number of living acarids | |
| after 6 weeks | CP |

| Reference | Mean | Standard deviation | Mean |
|---|---|---|---|
| 8-a | 848 | 50 | |
| 8-b | 257 | 24 | 72 |
| 8-c | 177 | 16 | 81 |

The control for growth of the acarid is in accordance with regard to the control knitted fabric.

The acarid-combating activity of the ZnS is encountered after the spinning and knitting stage: the addition of ZnS to the PA 6,6 checks the process of expansion of the population of the acarids.

### Knitted Fabrics Obtained According to Example 9

The results are as follows.

| | |
|---|---|
| Number of living acarids | |
| after 6 weeks | CP |

| Reference | Mean | Standard deviation | Mean |
|---|---|---|---|
| 9-a | 878 | 26 | |
| 9-b | 391 | 24 | 55 |
| 9-a1 | 809 | 46 | |
| 9-b1 | 348 | 34 | 57 |
| 9-a2 | 794 | 88 | |
| 9-b2 | 319 | 25 | 60 |

The control for growth of the acarids is in accordance with regard to the raw or dyed control knitted fabrics.

The acarid-combating activity of the ZnS is encountered after the spinning, knitting and dyeing stage: the addition of ZnS to the PA 6,6 checks the process of expansion of the population of the acarids.

### Fitted Carpets Obtained According to Example 10

The results are as follows.

| | |
|---|---|
| Number of living acarids | |
| after 6 weeks | CP |

| Reference | Mean | Standard deviation | Mean |
|---|---|---|---|
| 10-a1 | 852 | 27 | |
| 10-b1 | 258 | 44 | 70 |
| 10-c1 | 129 | 15 | 85 |
| 10-d1 | 800 | 30 | 7 |
| 10-a2 | 791 | 29 | |
| 10-b2 | 275 | 17 | 65 |
| 10-c2 | 112 | 12 | 86 |
| 10-d2 | 757 | 38 | 4 |

The control for growth of the acarids is in accordance with regard to the raw or dyed control fitted carpets.

The acarid-combating activity of the ZnS is encountered after the stage of spinning, of constructing the fitted carpet and of dyeing: the addition of ZnS to the PA 6,6 checks the process of expansion of the population of the acarids.

An additional test was carried out on the same dyed fitted carpets but allowing a period of time for growth of the acarids of 9 weeks instead of the 6 weeks normally used. The results are as follows.

| | |
|---|---|
| Number of living acarids | |
| after 9 weeks | CP |

| Reference | Mean | Standard deviation | Mean |
|---|---|---|---|
| 10-a2 | 1180 | 24 | |
| 10-c2 | 119 | 7 | 90 |
| 10-d2 | 1170 | 106 | 1 |

The control for growth of the acarids is in accordance with regard to the dyed control fitted carpets.

The acarid-combating activity of the ZnS is found confirmed over a longer time period and even has a tendency to become more pronounced.

### Adhesives Obtained According to Example 11

The results are as follows.

| | |
|---|---|
| Number of living acarids | |
| after 6 weeks | CP |

| Reference | Mean | Standard deviation | Mean |
|---|---|---|---|
| 11-a | 786 | 39 | |
| 11-b | 406 | 20 | 51 |

The control for growth of the acarids is in accordance with regard to the control knitted fabric.

### Example 14

### Characterization of the Behaviour with Respect to the Acarids of Pa Fitted Carpets Surface Treated with ZnS Powder

### Principle

The object of this study is to evaluate the effectiveness of a powder intended to be applied to floor coverings in a curative and/or preventive treatment for combating populations of dust mites.

This characterization is carried out in the same laboratory which carried out the test of Example 12. The source of the acarids is identical.

The test comprises two parts:
a curative test by deposition of the product on an existing population of acarids,
a preventive test with deposition of acarids on surfaces of fitted carpets treated beforehand with the product.

Monitoring is carried out over a period of at least two cycles, i.e. 6 weeks, and in comparison with a population not subjected to the product.

### Experimental Method

The experimental method is derived from the experimental context of the AFNOR standard NF G 39-011.

The experimental unit is composed of a chamber with a diameter of 8 cm which is escapeproof with regard to the acarids but which allows ventilation and in which are found:
a piece of short-pile polyamide fitted carpet as floor
5 g of nutrient medium (dust+skin scales)
the corresponding dose of the test powder.

The ZnS tested is ZnS 1.

### Curative Test Procedure:

approximately 50 active acarids are placed on the fitted carpets
the test product is mixed with the food and sprinkled with a salt cellar over the fitted carpet containing the acarids
4 repetitions are carried out on the same day as experimental factor, including for the control batches composed of the same device but without the product
the product is applied at a rate of 160 mg/m²
2 counts of the populations of acarids are carried out after incubating for 4 and 6 weeks under optimum development conditions.

### Preventive Test Procedure:

the product is mixed with the food and sprinkled with a salt cellar over pieces of acarid-free fitted carpets
one month later, approximately 50 active acarids are placed on the treated fitted carpets
4 repetitions are carried out as experimental factor, including for the control batches composed of the same device but without the product (same control as for the curative test)
the product is applied at the rate of 10, 40, 80 and 160 mg/m²
counting of the population of acarids is carried out after incubating for 6 weeks under optimum development conditions.
   The monitorings consist in counting the number of living acarids after the time period of 4 or 6 weeks of incubation.
   The method of counting the acarids and the calculation of the coefficient of regulation of the population of acarids (CP) are identical to Example 12.

$$C P = \frac{( \begin{matrix}Population on the untreated piec - \\ population on the untreated piece\end{matrix} )}{Population on the untreated piece } \times 100$$

The population counts on controlled and treated are all carried out at the same number of weeks.

### Experimental Plan

### Curative Test:

powder tested: 160 mg/m²
untreated control

### Preventive Test:

powder tested: 10, 40, 80 and 160 mg/m²
untreated control
   Experimental results
   The data for the various experimental series are summarized in the following tables:

### Curative Test

The results are as follows.

| | | Number of | | | Number of | | |
|---|---|---|---|---|---|---|---|
| | | living acarids | | | living acarids | | |
| | | after 4 weeks | | CP 4 | after 6 weeks | | CP 6 |
| | Amount | | Standard | weeks | | Standard | weeks |
| Treatment | (mg/m²) | Mean | deviation | Mean | Mean | deviation | Mean |
| Nothing | | 257 | 39 | | 905 | 32 | |
| ZnS 1 | 160 | 148 | 26 | 42 | 284 | 26 | 69 |

The control for growth of the acarids is in accordance with regard to the untreated fitted carpet.

The acarid-combating activity of the ZnS is found and the effect increases with incubation time.

### Preventive Test

The results are as follows.

| | | Number of | | | Number of | | |
|---|---|---|---|---|---|---|---|
| | | living acarids | | | living acarids | | |
| | | after 4 weeks | | CP 4 | after 6 weeks | | CP 6 |
| | Amount | | Standard | weeks | | Standard | weeks |
| Treatment | (mg/m²) | Mean | deviation | Mean | Mean | deviation | Mean |
| Nothing | | 257 | 39 | | 905 | 32 | |
| ZnS 1 | 10 | 242 | 29 | 6 | 849 | 37 | 6 |
| ZnS 1 | 40 | 154 | 19 | 40 | 361 | 20 | 60 |
| ZnS 1 | 80 | 142 | 14 | 45 | 315 | 33 | 65 |
| ZnS 1 | 160 | 123 | 12 | 52 | 290 | 28 | 68 |

The control for growth of the acarids is in accordance with regard to the untreated fitted carpet.

The acarid-combating activity of the ZnS is found and the effect increases with the incubation time and the concentration deposited on the fitted carpet.

### Example 15

### Liquid Composition with Acarid-Combating Properties for Textile Surfaces

| Ingredients | Function | % by mass |
|---|---|---|
| Water | | 90.5% |
| ZnS | | 1% |
| Acrylic polymer | | 0.2% |
| 2-Amino-2-methyl-1-propanol | | 0.2% |
| 7 EO ethoxylated C₁₂-C₁₄ alcohol | Nonionic | 0.1% |
| | surfactant | |
| Isoparaffin hydrocarbon | Solvent | 8% |

### Example 16

### Liquid Composition with Acarid-Combating Properties for Textile Surfaces

| Ingredients | Function | % by mass |
|---|---|---|
| Water | | 75.5% |
| ZnS | | 2% |
| Sodium lauryl ether sulphate | Anionic | 10% |
| | surfactant | |
| Disodium lauramide | Anionic | 10% |
| sulphosuccinate | surfactant | |
| Isopropanol | Solvent | 2% |
| EDTA (ethylenediaminetetraacetic | Sequestering | 0.5% |
| acid) | agent | |

### Example 17

### Liquid Stain-Removing Composition with Acarid-Combating Properties for Textile Surfaces

| Ingredients | Function | % by mass |
|---|---|---|
| Water | | 93.72% |
| ZnS | | 0.08% |
| Tripropylene glycol methyl ether | Hydrophobic | 5% |
| | solvent | |
| 2.6 EO ethoxylated C₁₀-C₁₂ alcohol | Nonionic | 0.5% |
| | surfactant | |
| Sodium lauryl sulphate | Anionic | 0.3% |
| | surfactant | |
| EDTA | Sequestering | 0.4% |
| | agent | |

### Example 18

### Pulverulent Composition with Acarid-Combating Properties for Cleaning Fitted Carpets

| Ingredients | Function | % by mass |
|---|---|---|
| Sodium borate decahydrate | | 79% |
| ZnS | | 1% |
| Aluminium oxide | | 12% |
| Ethylene glycol monoethyl ether | | 6% |
| Linear alcohol polyethylene | Nonionic | 1% |
| glycol | surfactant | |
| Fragrance | | 0.5% |
| Anticaking agent | | 0.5% |

### Example 19

### Aerosol Composition with Acarid-Combating Properties for Cleaning Fitted Carpets

| Ingredients | Function | % by mass |
|---|---|---|
| Sodium lauryl sulphate | Foaming | 2.5% |
| | surfactant | |
| ZnS | | 1% |
| Sodium lauryl sarcosinate | Anionic | 3.5% |
| | surfactant | |
| Dipropylene glycol n-propyl ether | Solvent | 3% |
| Polyethylene glycol monooleate | | 0.3% |
| Isobutane | Propellant | 4.25% |
| Propane | Propellant | 0.75% |
| Fragrance | | 0.5% |
| Sodium tetraborate | Oxidizing | 0.75% |
| | agent | |
| Water | | 83.45% |

What is claimed is:

1. A process for combating acarids comprising applying to said acarids or to their environment an effective anti-acarid amount of zinc sulfide.

2. A process for combating acarids comprising applying to said acarids or to their environment a composition comprising an anti-acarid amount of zinc sulfide and at least one additive.

3. The process according to claim 2, wherein the compositions are formulations suitable for the sizing of yarns, fibers or filaments.

4. The process according to claim 1, wherein the compositions are liquid or solid compositions suitable for cleaning, treating, or cleaning and treating textile surfaces.

5. The process according to claim 1, wherein a polymeric composition comprising zinc sulfide is spun in the preparation of yarns, fibers or filaments.

6. The process according to claim 5, wherein the polymeric composition comprises a thermoplastic matrix.

7. The process according to claim 6, wherein the thermoplastic matrix is a polyamide, a copolyamide or an alloy of polyamides.

8. The process according to claim 6, wherein the thermoplastic matrix is a polyester, a copolyester or an alloy of polyesters.

9. The process according to claim 5, further comprising preparing an article from the yarns, fibers or filaments thus obtained.

10. The process according to claim 2, further comprising preparing a composite textile article, the zinc sulfide being present in at least one of the components of the article.

11. The process according to claim 10, wherein the textile article is a flocked surface.

12. The process according to claim 10, wherein the textile article is a tufted surface.
